(19) United States
(12) Patent Application Publication
(10) Pub. No.: US 2016/0269297 A1
(43) Pub. Date: Sep. 15, 2016

(54) Scaling the LTE Control Plane for Future Mobile Access

(71) Applicant: NEC Laboratories America, Inc., Princeton, NJ (US)

(72) Inventors: Rajesh Mahindra, Princeton, NJ (US); Karthikeyan Sundaresan, Howell, NJ (US); Arijit Banerjee, Durham, NC (US); Sampath Rangarajan, Bridgewater, NJ (US)

(21) Appl. No.: 15/064,665

(22) Filed: Mar. 9, 2016

Related U.S. Application Data
(60) Provisional application No. 62/130,845, filed on Mar. 10, 2015.

(51) Int. Cl. H04L 12/803; H04L 12/743

(52) U.S. Cl. CPC H04L 47/125; H04L 45/7453

(57) ABSTRACT

Methods and systems for load balancing on a control plane include calculating a hash of a unique identifier using a processor. The unique identifier is associated with a requesting device issuing a control request. The hash is mapped to a control plane processing device. The control request is forwarded to the control plane processing device.

### RELATED APPLICATION INFORMATION

This application claims priority to provisional application 62/130,845, filed Mar. 10, 2015, the contents thereof being incorporated herein by reference.

### BACKGROUND OF THE INVENTION

Mobile networks are ubiquitous, and with the forward pace of miniaturization and decreased access costs, more devices are being designed to take advantage of such networks for connectivity. In addition to the dramatic increase in mobile phone usage following the advent of the smart phone, mobile networks are used by the “internet of things” to transmit a wide variety of information relating to the operation of devices including, e.g., home security and automation, appliances, automobile telemetry, and more.

In one particular example, long-term evolution (LTE) mobile networks are a modern example of a technology that is being forced to scale with the rapidly increasing number of devices. A consequence of this proliferation is referred to as a “signaling storm,” where the increase in control signaling traffic for devices has increased dramatically and threatens to overwhelm the existing networks. This is a consequence not only of the increase in the number of devices, but of the types of use. For example, some applications necessitate continuous synchronization with external servers and, furthermore, poorly designed applications demand far more network resources than are strictly needed. In addition, the increase in the density of small cells causes an increase in signaling that results from handling user transitions from cell to cell.

As a result, the control plane of an LTE base station may be overloaded, with such overload causing significant delays in the processing of control messages, directly impacting users' quality of service. Recent attempts to scale LTE management have involved ground-up redesigns, for example applying software defined networking concepts to the LTE core networks to provide a more scalable control plane. These proposals have thus far been inadequate, either doing too little to solve the problem or failing to account for other needs such as power management, quality of service policies, billing, etc.

### BRIEF SUMMARY OF THE INVENTION

A method for load balancing on a control plane includes calculating a hash of a unique identifier using a processor, said unique identifier being associated with a requesting device issuing a control request. The hash is mapped to a control plane processing device. The control request is forwarded to the control plane processing device.

A load balancer includes a hashing module comprising a processor configured to calculate a hash of a unique identifier, said unique identifier being associated with a requesting device issuing a control request, and mapping the hash to a control plane processing device. A load balancing module is configured to forward the control request to the control plane processing device.

### BRIEF DESCRIPTION OF THE DRAWINGS

FIG. 1 is a block diagram of a mobile network with distributed mobility management in accordance with the present principles;

FIG. 2 is a block diagram of a distributed mobility management entity in accordance with the present principles;

FIG. 3 is a block/flow diagram of a method for processing a control request by a distributed mobility management entity in accordance with the present principles;

FIG. 4 is a block/flow diagram of a method for processing a control request by a distributed mobility management entity in accordance with the present principles;

FIG. 5 is a block diagram of a processing system in accordance with the present principles; and

FIG. 6 is a block diagram of a mobility management entity load balancer in accordance with the present principles.

### DETAILED DESCRIPTION

Embodiments of the present invention take advantage of distributed computing and network architectures to provide network function virtualization. The present embodiments thereby virtualize key control plane elements in the network. In the example of long-term evolution (LTE) networks, the mobility management entity (MME) is virtualized to provide scalability in control signal management. This ensures a cost-effective solution to network signaling scalability, but also allows for incremental deployment while retaining standards compliance, making the present embodiments applicable to existing networks.

While it may seem straightforward to virtualize the MME by simply porting existing code to a virtualized cloud platform, there are at least two difficulties to be overcome. First, the concepts behind distributed systems in information technology clouds cannot be directly applied to telecommunication services, as the latter have unique characteristics that need to be considered. For example, control sessions with devices are typically persistent, with each device being associated with a context or state, thereby requiring the platform to perform both state and computation management. Furthermore, operator data centers are typically resource constrained, but geographically distributed.

Second, current MME deployments suffer from an inability to perform fine-grained load balancing due to devices being statically assigned to MMEs. Furthermore, MMEs have inefficient elasticity, as scaling out involves manual intervention and static configurations. In addition, high overheads when rebalancing load across MMEs affects scalability. Once a particular MME overloads, signaling messages are generated per-device to reassign the devices to other MMEs. Hence, existing MMEs are poorly designed for over-provisioned systems with only a few dedicated servers that undergo infrequent capacity expansion and which support a limited number of devices.

The present embodiments therefore decouple the MME processing from the standard interfaces. To ensure scalability with a large number of devices, the present embodiments adopt a decentralized approach that uses constant hashing to efficiently assign and reassign devices across the MMEs. To provide efficient load balancing, the present embodiments replicate device contexts across virtual machines (VMs) to ensure that multiple VMs can process a device request in case of intermittent overloads. Device contexts are also selectively replicated externally across data centers to take advantage of spatial multiplexing of processing capacity across the data centers. The present embodiments furthermore take advantage of access patterns of devices, if available, to improve replication decisions within and across data centers.

While the present embodiments are discussed with particular focus on LTE networks, it should be understood that the present principles may be applied with equal effectiveness to any network to scale with increased control signal traffic.

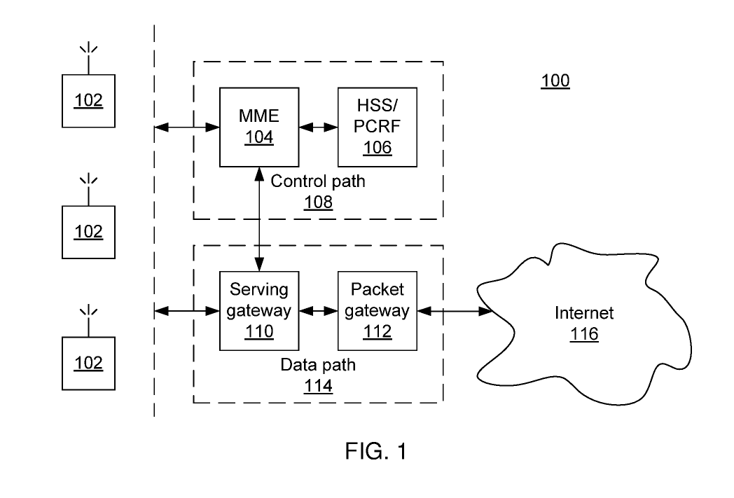

Referring now to FIG. 1, an exemplary mobile network 100 is shown. The network includes a number of nodes 102, which may for example include mobile telephones or other network-enabled devices. In the specific embodiment based in LTE, the nodes 102 may be referred to as “eNodeBs.” The nodes 102 communicate along two different paths—a control path 108 and a data path 114—which together make up an “evolved packet core.” On the control path 108, the nodes 102 communicate with the MME(s) 104 for control signaling which, in turn, communicates with home subscriber server (HSS)/policy and charging rules function (PCRF) 106. The HSS holds user subscription information and the PCRF is a policy engine that enforces quality of service and accounting rules for each node 102. On the data path 114, data traffic passes through a serving gateway 110 and one or more packet data network gateways 112 to provide connectivity to the internet 116.

The MME 104 is the control node for the network 100, as it manages both connectivity and mobility for the nodes 102. The MME provides authentication and integrity checks, selection of the service gateway 110, location tracking, and cell handovers. In addition to being the entry point for control plane messages from the devices, it manages other control plane entities using standard interfaces. For example, MME 104 maintains the S 1, S6, and S 11 protocols in LTE with the nodes 102, the server gateway 110, and the HSS/PCRF 106 respectively.

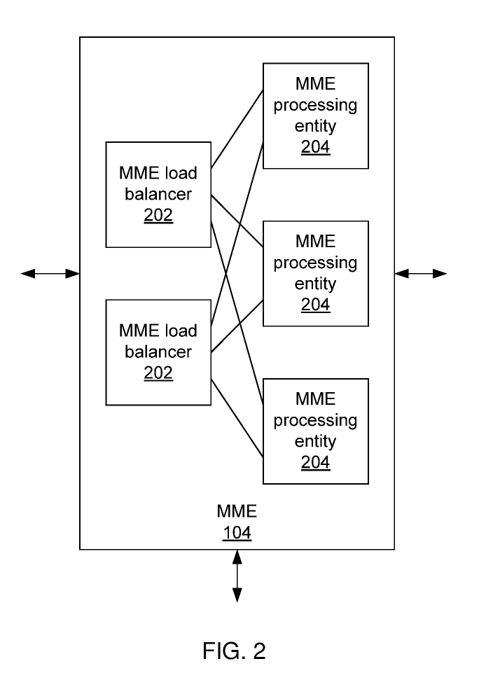

Referring now to FIG. 2, additional detail on the MME(s) 104 is shown. The present embodiments provide a framework for efficient virtualization of MME control plane functions. Conventional MME platforms are too rigid to provide scalability. To overcome the rigidity of conventional MME systems, the present embodiments decentralize the MME 104 and minimize the amount of information exchange across VMs. To meet performance and cost targets, the present embodiments efficiently manage the processing load on MME VMs to reduce control plane latencies or, alternatively, to achieve a target latency with fewer VMs. The result is a decentralized MME system 104 that provides elasticity and standards compliance with existing implementations.

The decentralized MME 104 includes MME load balancers 202 and MME processing entities 204. The MME load balancers 202 interface with other network entities via standard interfaces. For example the MME load balancers establish S1 and S11 interfaces with the nodes 102 and the server gateway 110 respectively. The MME load balancers 202 negate the effect of device assignment and request routing decisions taken by the nodes 102—the nodes 102 simply choose the MME load balancer 202 to route a device request to and the MME load balancer forwards that request to the appropriate MME processing entity VM 204. The MME load balancers 202 thereby ensure that device assignment and reassignment decisions within the MME processing entities 204 can be performed without affecting either the nodes 102 or the server gateways 110.

The MME processing function is virtualized over a cluster of MME processing entity VMs 204, such that the MME processing entities 204 form an MME pool to process requests from all nodes 102 belonging to, for example, a geographic area belonging to that pool. Each MME processing VM 204 of a certain pool can process requests from nodes 102 assigned to different MMEs 104 in that pool. This means that device-to-MME mapping information is stored for each device 102 at the MME processing VMs 204. The present embodiments add this information to existing state information that the MME processing VMs 204 already store for each device. This design improves utilization of the cluster, as the nodes 102 belonging to a particular data center can be flexibly assigned across the MME processing VMs 204. Because the interface between the MME load balancers 202 and the MME processing entities 204 is internal to the distributed MME system 104 and not defined by any existing standard, any appropriate interface may be used.

The present embodiments carefully manage the state of existing and new nodes 102 by jointly considering both memory and computational resources. To achieve this, the distributed MME system 104 partitions device states across active MME processing VMs 204 and determines the number of copies needed for each state to balance between effective load balancing and synchronization costs.

The present embodiments use consistent hashing to assign device states to the active MME processing VMs 204. In consistent hashing, the output range of a hash function is treated as a fixed circular ring. In other words, the largest hash value wraps around to the smallest hash value. Each MME processing VM 204 is represented by a set of tokens (random numbers) so that each MME processing VM 204 is assigned to multiple points on the ring. Each node 102 is assigned to an MME processing VM 204 by first hashing the device's unique identifier to yield a position for the device 102 on the hash ring. The ring is then traversed in a “clockwise” direction to determine the first MME processing VM 204 that has a position larger than the device's position on the hash ring. This MME processing VM 204 becomes the master for that device 102. Thus, each MME processing VM 204 becomes responsible for the region on the ring between it and its predecessor MME processing VM 204. When an MME processing VM 204 is added or removed to scale, the transfer of device states only affects immediate neighbors in the ring, causing minimal reorganization. Partitioning the device states using consistent hashing ensures that MME processing VMs 204 scale incrementally in a decentralized way and that the MME load balancers 202 do not need to maintain routing tables for device-to-MME-proces sing mapping, making the load balancers 202 efficient in terms of both memory usage as well as increasing lookup speeds and, hence, scalability.

State replication is used to handle unexpected surges in the number of active devices, which might otherwise cause intermittent overloads in the MME processing VMs 204. The number of replicas, R, is set as a balance between better load balancing and storage and synchronization costs. To find a balance between these conflicting goals, a stochastic analysis is used to model the impact of replication in consistent hashing on load balancing. If no replications are made, as the arrival rate increases, the load on the MME processing VMs 204 increases, causing higher processing delays for requests. However, by replicating the state of a node 102 in just one other MME processing VM 204, the delays experienced by the node 102 are greatly reduced, with further replications providing only a marginal benefit.

In addition to determining the number of replications, placement of the replicas is also determined. Using consistent hashing, the devices states are distributed uniformly between MME processing VMs 204. Hence, even with a single replication per device 102, the device states assigned to a particular MME processing VM 204 end up being replicated across multiple other MME processing VMs 204, thereby avoiding hotspots during replication.

The MME processing VMs 204 are provisioned every epoch. The number of MME processing VMs 204 needed is estimated by considering the maximum processing and storage needs. For scalability, the MME processing VMs 204 are provisioned independently at each data center based on the expected load for the current epoch, which in turn is estimated from the average signaling load generated in prior epochs. Thus, the number of MME processing VMs 204 needed to meet processing and memory constraints for a data center j for an upcoming epoch t is given as:

$$V ( t ) = max ( {V}_{C} ( t ) , {V}_{S} ( t ) )$$

$$where$$

$${V}_{C} ( t ) = ⌈ ( \frac{\overline{L} ( t )}{N} ) ⌉$$

$${V}_{S} ( t ) = ⌈ β ( \frac{R \cdot K ( t )}{S} ) ⌉$$

The parameter β=(0,1] is used to control provisioning, R=2 is the number of replicas needed for each device, the function K(t) represents the number of registered devices, L̅(t) is the average expected signaling load from the existing devices in the upcoming epoch, N is the number of requests that each MME processing VM 204 can process in every epoch, S is the maximum number of devices whose state can be stored at a particular MME processing VM 204, V_{C} (t) is the number of MME processing VMs 204 needed to meet processing constraints, and V_{S}(t) is the number of MME processing VMs 204 needed to meet storage constraints. The average expected signaling load L(t) is estimated as a moving average of actual load L(t) and average loads from a prior epoch:

L̅(t←αL(t−1)+(1−α)L̅(t−1)

where α is a parameter determining the weighting of the averages from the prior epoch.

The choice of β plays a significant role in provisioning. The number of total nodes 102 will generally be much higher than the number of active devices, and a large fraction of the nodes 102 will have a low probability of access in any given epoch. Hence, blindly accommodating R copies of each node state would result in the storage component dominating the VM provisioning costs. While β can be used as a control parameter to restrict the VM provisioning costs, this will amount to some nodes 102 not being replicated and could lead to increased processing delays for nodes 102. Hence the selection of β and the decision of which nodes' states will be replicated is significant.

The present embodiments track the average access frequency of a node 102 in an epoch (as a moving average) and includes the average access frequency with the rest of the state that is already stored for the node 102. Some nodes 102 are expected to have predictable access patterns, which contribute to more accurate profiling of node access frequency. The access frequency information is therefore used to determine if the state of a node 102 should be replicated, reducing provisioning costs.

Toward this end, the present embodiments estimate the number \hat{K}(x) of nodes 102 with low access probability wᵢ≦x (with an exemplary value x=0.1) for which a single replication (i.e., R=1) of the state should suffice. This allows for a net state reduction of R(x)=Σᵢ1_{(w}_{ᵢ}_{≦x)}. This reclaimed storage may be used to accommodate new or migrating nodes Sₙ 102 that may register with the data center in the epoch, as well as for the state of nodes 102 Sₘ from remote data centers for multiplexing. Thus, only \hat{K}(x)−Sₙ−Sₘ nodes effectively contribute to the reduction in storage, resulting in:

$$β ( x ) = 1 - \frac{\hat{K} - {S}_{n} - {S}_{m}}{RK}$$

By increasing the fraction of devices whose state is not replicated (e.g., by increasing x), the value β(x) is also reduced, thus reducing provisioning cost.

Based on the distribution of access probabilities of devices, an appropriate β(x) can be used to determine the provisioning. Once provisioning is complete, the actual replication of node states is executed in an access-aware manner as follows. First, each node state is stored in its master MME processing VM 204, which is the VM 204 that the node state hashed to. Second, the replica of the state is stored in the neighboring MME processing VM 204 on the hash ring, based on the remaining storage and access probability, as

$${ℙ}_{i} ( rep ) = ( \frac{{w}_{i}}{{Σ}_{j} {w}_{j}} ) ( VS - {S}_{n} - {S}_{m} - L )$$

By provisioning resources and maintaining separate hash rings for MME processing VMs 204 at each individual data center, the present embodiments ensure that the master MME processing VM 204 for each node 102 is located in that node's local data center. This minimizes delays by processing as many requests as possible at the local data center. However, to load balance the processing across data centers during periods of overloads, the present embodiments make room (St) in each data center i for the state of nodes 102 in other data centers (j # i) and decide which nodes 102 in a data center will have their state replicated remotely and in which remote data center. While the former is handled by the data center, the latter is handled by the MME processing VMs 204 independently for scalability.

Each data center I independently chooses Sₘⁱ (called a “state budget”) to capture potential under-load in processing an epoch. This indicates the maximum amount of external node state it will accept from external data centers. The data center maintains and updates a variable that represents the current amount of remaining external device state. The data center periodically broadcasts the value of to the neighboring data centers and periodically updates the value of Sₘⁱ to track the average processing load and potential for under-load (until a maximum threshold is reached). If at any point Ŝₘⁱ≧Sₘⁱ, the data center i requests other data centers to appropriately reduce their share of device states stored in data center i to reflect the reduction in S.

With each data center i making room for external states, an equivalent amount of room Sₘⁱ is maintained for nodes 102 to have their state replicated remotely (to ensure conservation of external state resources across data centers). However, one goal for the data centers is to process most of their high probability devices locally to keep processing delays low. At the same time, storing low probability device states remotely will not help multiplex significant resources from remote data centers, since the probability of those devices appearing is low to begin with. To balance between processing delays and resource multiplexing, each MME processing entity 204 vₖ selects its share of Sₘⁱ/v devices of high probability (e.g., the probability for a device I, wᵢ≧0.5) in an epoch, to be replicated once in the external space (e.g., Sₘⁱ,j# i) reserved by one of the remote data centers. However, this replication is in addition to the two copies that are stored locally for high-probability devices so as minimize the effect on their processing delays. The present embodiments replicate the state of a device 102 with w₁≧0.5 externally with probability:

$$( \frac{{w}_{i}}{{Σ}_{j ∈ {v}_{k} \text{:} {w}_{j} \geq 0.5} {w}_{j}} ) ( \frac{{S}_{m}^{i}}{V} )$$

Once a device's state is selected by an MME processing entity 204 for external replication, the MME processing entity 204 determines the appropriate destination data center for the state based on two factors: the remote data center's current occupancy by external state and inter-data-center propagation delay. The MME processing entity 204 checks if at least one data center j has available budget for external state (e.g., Ŝₘⁱ≧0 and, if multiple remote data centers have non-zero budget, selects a data center according to the following metric:

$$p = \frac{{D}_{ik}}{{\sum }_{i = 1}^{C} {D}_{ij}}$$

where Dᵢⱼ is the propagation delay between data centers i and j, C is the total number of remote data centers with non-zero budget. The MME processing entity 204 deletes its share of external state replications at data center j if requested by the data center by a percentage, starting with those states having a relatively low access probability.

The present embodiments thereby probabilistically replicate the state of some select devices 102 at a given data center to remote data centers, while accounting for the inter-data-center propagation delays to ensure that hot spots are avoided in cases where certain data centers with relatively low propagation delays receive a lot of external state and that processing delays are reduced within each data center through multiplexing in a scalable, decentralized way.

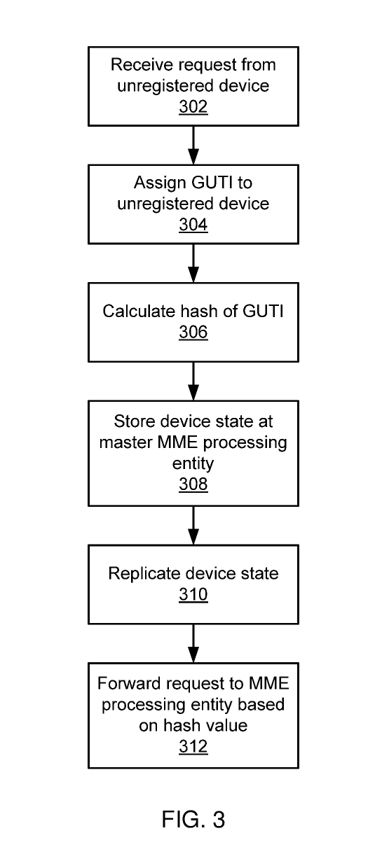

Referring now to FIG. 3, a method of handling requests from an unregistered device is shown. This method is performed at, e.g., an MME load balancer 202. At block 302, the MME load balancer 202 receives a request from an unregistered device, at which time block 304 assigns a new globally unique temporary ID (GUTI) to the device. Block 306 calculates a hash of the GUTI, producing a position on the consistent hash ring.

The position indicated by the hash of the GUTI represents a master MME processing entity 204 for the device 102. Block 308 stores the device state at the master MME processing entity 204 and block 310 then replicates the device state at, e.g., a neighboring MME processing entity 204 on the hash ring. Block 312 then forwards the request to a master MME processing entity 204 based on the hash value of the assigned GUTI.

In the case of a request from an existing device, the load balancing process is more involved. Online load balancing is designed to impose minimal effort on the MME load balancers 202 to ensure fast lookup speeds when routing requests to the MME processing entities 204. Specifically, the MME load balancers 202 are unaware of the number and placement of the replicas of the state of a device to avoid storage and exchange of per-device information. Hence, the only metadata information taken by the MME load balancers 202 are the updated consistent hash ring as MME processing entities 204 are added or removed and the instantaneous load on each MME processing entity 204.

In addition, the processing needs for a device 102 is higher while it is in an “active” mode. The processing delays are furthermore more important when the device 102 makes a transition from an “idle” to an “active” mode. The MME load balancers 202 therefore assign the least-loaded MME processing entity 204 among the choices for a request when a device 102 makes a transition to the “active” mode. Subsequent requests are sent to the same MME processing entity 204 until the device 102 makes a transition back to the “idle” mode. By load balancing only when the device 102 enters the “active” mode, the MME 104 only performs updates of the replicas when the device 102 goes back to the “idle” state.

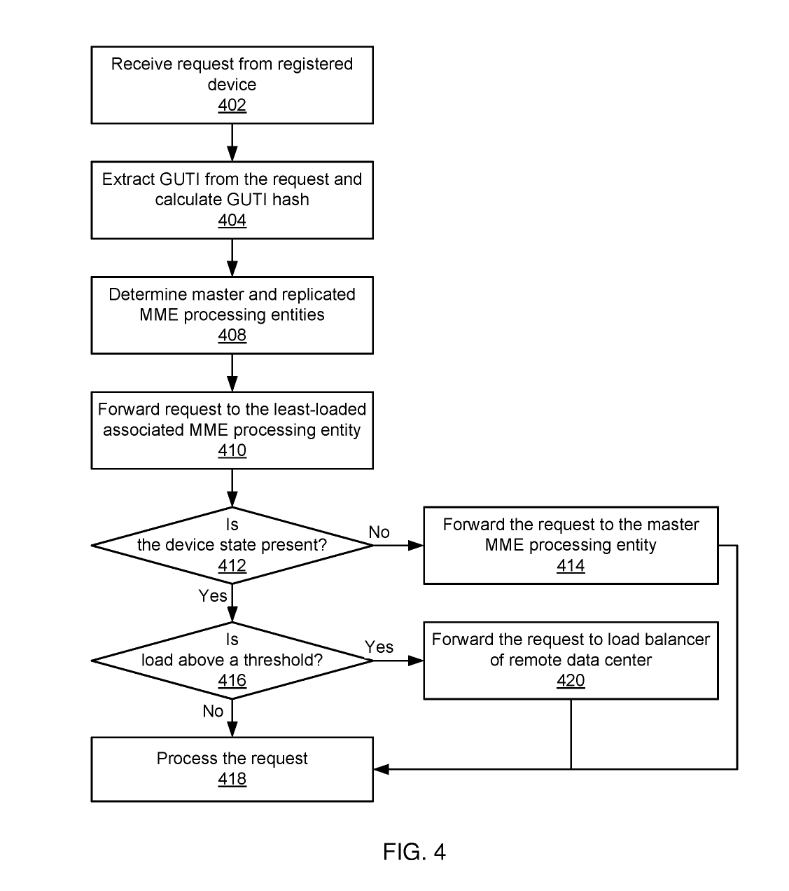

Referring now to FIG. 4, a method of handling requests from a registered device is shown. Block 402 receives the request from a registered device at a MME load balancer 202. The MME load balancer 202 extracts the GUTI from the request and calculates a hash of the GUTI in block 404. Block 408 determines a position on the consistent hash ring for the master MME processing entity 204 and the MME processing entities 204 hosting any replications based on the hash of the GUTI. Block 410 forwards the request to the MME processing entity 204 having the lowest load.

Block 412 determines whether the device state is present at the assigned MME processing entity 204. If not, the request is forwarded to the master MME processing entity 414 and the request is processed at block 418. If the device state is present, block 416 determines whether the load at the assigned MME processing entity 204 is above a threshold. If so, the request is forwarded to an MME load balancer 202 at a remote data center where the device's state has been externally replicated, where block 418 processes the request. If not, the assigned MME processing entity 204 processes the request at block 418.

It should be understood that embodiments described herein may be entirely hardware, entirely software or including both hardware and software elements. In a preferred embodiment, the present invention is implemented in hardware and software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

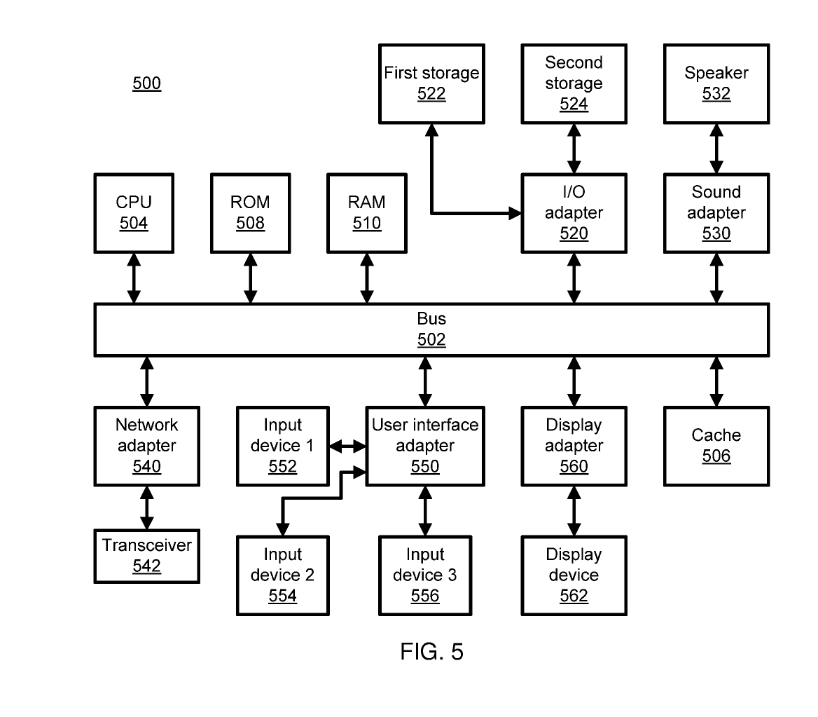

Referring now to FIG. 5, an exemplary processing system 500 is shown which may represent MME load balancers 202. The processing system 500 includes at least one processor (CPU) 504 operatively coupled to other components via a system bus 502. A cache 506, a Read Only Memory (ROM) 508, a Random Access Memory (RAM) 510, an input/output I/O) adapter 520, a sound adapter 530, a network adapter 540, a user interface adapter 550, and a display adapter 560, are operatively coupled to the system bus 502.

A first storage device 522 and a second storage device 524 are operatively coupled to system bus 502 by the I/O adapter 520. The storage devices 522 and 524 can be any of a disk storage device (e.g., a magnetic or optical disk storage device), a solid state magnetic device, and so forth. The storage devices 522 and 524 can be the same type of storage device or different types of storage devices.

A speaker 532 is operatively coupled to system bus 502 by the sound adapter 530. A transceiver 542 is operatively coupled to system bus 502 by network adapter 540. A display device 562 is operatively coupled to system bus 502 by display adapter 560.

A first user input device 552, a second user input device 554, and a third user input device 556 are operatively coupled to system bus 502 by user interface adapter 550. The user input devices 552, 554, and 556 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 552, 554, and 556 can be the same type of user input device or different types of user input devices. The user input devices 552, 554, and 556 are used to input and output information to and from system 500.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present principles provided herein.

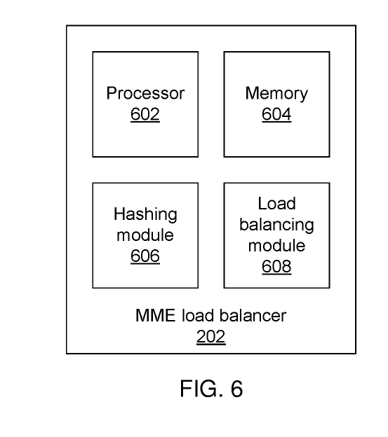

Referring now to FIG. 6, a block diagram of an MME load balancer 202 is shown. The MME load balancer 202 includes a hardware processor 602 and memory 604. In addition, the MME load balancer 202 includes one or more functional modules. The functional modules may be implemented as software that is stored in memory 604 and executed on processor 602. In alternative embodiments, the functional modules may be implemented as one or more discrete, special-purpose hardware devices in the form of, e.g., application specific integrated chips or field programmable gate arrays.

The MME load balancer 202 uses a hashing module to calculate a hash value of a GUTI associated with a device 102. The hash value corresponds with a position on a consistent hash ring which, in turn, corresponds with an MME processing entity 204. Load balancing module 608 forwards requests to the appropriate MME processing entity 204 and also manages replication of device state. The load balancing module 608 thereby provides scalability as the number of devices 102 increases, preventing hot spots at any one MME processing entity 204.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in Appendix A to the application. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for load balancing on a control plane, comprising:
calculating a hash of a unique identifier using a processor, said unique identifier being associated with a requesting device issuing a control request;
mapping the hash to a control plane processing device; and
forwarding the control request to the control plane processing device.

2. The method of claim 1, further comprising forwarding a state of the requesting device to the mapped control plane processing device if the requesting device is unregistered.

3. The method of claim 2, further comprising replicating the state of the requesting device at a second control plane processing device that is a neighbor on a consistent hash ring to the mapped control plane processing device.

4. The method of claim 3, wherein replicating the state of the requesting device comprises determining that the requesting device has an access probability greater than a threshold probability.

5. The method of claim 3, further comprising replicating the state of the requesting device at a third control plane processing device that is geographically separated from the first and second control plane processing devices.

6. The method of claim 1, wherein mapping the hash to the control plane processing device comprises mapping the hash to a consistent hash ring that includes a plurality of control plane processing devices, such that the hash maps to and identifies a master control plane processing device.

7. The method of claim 6, wherein mapping the hash to the control plane processing device comprises forwarding the request to one of the master control plane processing device and a replicated control plane processing device based on which control plane processing device has a lowest load.

8. The method of claim 7, wherein the replicated control plane processing device occupies a position on the consistent hash ring next to the master control plane processing device.

9. The method of claim 7, wherein the master control plane processing device and the replicated control plane processing device each store a state of the requesting device.

10. The method of claim 1, wherein the control plane processing device is a mobility management entity processing entity in a long term evolution wireless network.

11. A load balancer, comprising:
a hashing module comprising a processor configured to calculate a hash of a unique identifier, said unique identifier being associated with a requesting device issuing a control request, and mapping the hash to a control plane processing device; and
a load balancing module configured to forward the control request to the control plane processing device.

12. The load balancer of claim 11, wherein the load balancing module is further configured to forward a state of the requesting device to the mapped control plane processing device if the requesting device is unregistered.

13. The load balancer of claim 12, wherein the load balancing module is further configured to replicate the state of the requesting device at a second control plane processing device that is a neighbor on a consistent hash ring to the mapped control plane processing device.

14. The load balancer of claim 13, wherein the load balancing module is further configured to replicate the state of the requesting device if the requesting device has an access probability greater than a threshold probability.

15. The load balancer of claim 13, wherein the load balancing module is further configured to replicate the state of the requesting device at a third control plane processing device that is geographically separated from the first and second control plane processing devices.

16. The load balancer of claim 11, wherein the hashing module is further configured to map the hash to a consistent hash ring that includes a plurality of control plane processing devices, such that the hash maps to and identifies a master control plane processing device.

17. The load balancer of claim 16, wherein mapping the hashing module is further configured to forward the request to one of the master control plane processing device and a replicated control plane processing device based on which control plane processing device has a lowest load.

18. The load balancer of claim 17, wherein the replicated control plane processing device occupies a position on the consistent hash ring next to the master control plane processing device.

19. The load balancer of claim 17, wherein the master control plane processing device and the replicated control plane processing device each store a state of the requesting device.

20. The load balancer of claim 11, wherein the control plane processing device is a mobility management entity processing entity in a long term evolution wireless network.
